(19) United States
(12) Patent Application Publication
(10) Pub. No.: US 2023/0326648 A1
(43) Pub. Date: Oct. 12, 2023

(54) TRANSFORMER BOBBIN ASSEMBLY WITH INTEGRATED FINS

(71) Applicant: Hamilton Sundstrand Corporation, Charlotte, NC (US)

(72) Inventors: Stephen H. Taylor, East Hartford, CT (US); Yasmin Khakpour, South Windsor, CT (US); Jagadeesh K. Tangudu, South Windsor, CT (US); Lei Xing, South Windsor, CT (US)

(21) Appl. No.: 17/714,292

(22) Filed: Apr. 6, 2022

(51) Int. Cl. H01F 27/00; H01F 27/24

(52) U.S. Cl. CPC H01F 27/008; H01F 27/24

(57) ABSTRACT

A transformer bobbin includes a first bobbin member including a first end defining a first opening, a second end defining a second opening, an inner surface defining the first opening and an outer surface. The inner surface includes a first plurality of fins that extend between the first end and the second end. A second bobbin member is disposed about and spaced from the first bobbin member. The second bobbin member includes a first end portion defining a first opening portion, a second end portion, an inner surface portion and an outer surface portion. One of the outer surface of the first bobbin member and the outer surface portion of the second bobbin member includes a second plurality of fins that extend between the first end portion and the second end portion.

### STATEMENT OF FEDERAL SUPPORT

This invention was made with Government support under DE-OE0000905 awarded by the Department of Energy. The Government has certain rights in the invention.

### BACKGROUND

Exemplary embodiments pertain to the art of transformers and, more particularly, to a transformer bobbin assembly having integrated fins.

Transformers typically include a core formed from an electrically conductive material that is wrapped by an electrically conductive winding. The core typically includes first and second limbs joined by first and second yokes to form a continuous flux path. That is, the first and second limbs form side portions of the core while the first and second yoke form end portions of the solid core. There is typically an insulator disposed between the core and the winding. Typically, the transformer will include a first winding disposed about the first limb of the core and a second winding disposed about the second limb of the core. During operation, the core and the windings generate heat that, if not removed, can reduce an overall operational efficiency of the transformer.

For a single layer transformer, that is a transformer in which only one winding is disposed about each of the first and second portions of the core, air is typically directed over the windings and core as a heat exchange medium. Transformers that operate at higher voltages or that include multi-layered windings may use oil as the heat exchange medium. Air, even forced air, is inefficient as a heat exchange medium for many modern high voltage multi-layered winding transformers. Using oil as a heat exchange medium is more efficient than air, but is not feasible for many operating environments.

### BRIEF DESCRIPTION

Disclosed, in accordance with a non-limiting example, is a transformer bobbin including a first bobbin member including a first end defining a first opening, a second end defining a second opening, an inner surface defining the first opening and an outer surface. The inner surface includes a first plurality of fins that extend between the first end and the second end. A second bobbin member is disposed about and spaced from the first bobbin member. The second bobbin member includes a first end portion defining a first opening portion, a second end portion, an inner surface portion and an outer surface portion. One of the outer surface of the first bobbin member and the outer surface portion of the second bobbin member includes a second plurality of fins that extend between the first end portion and the second end portion.

Additionally, or alternatively, in this or other non-limiting examples, a third bobbin member is disposed about and spaced from the second bobbin member, the third bobbin member including a first end section defining a first opening section, a second end section, an inner surface section and an outer surface section, wherein one of the outer surface section and the inner surface section include a plurality of winding support members that extend between the first end section and the second end section.

Additionally, or alternatively, in this or other non-limiting examples, the first plurality of fins includes a first fin-to-fin spacing and the second plurality of fins includes a second fin-to-fin spacing, the first fin-to-fin spacing being distinct from the second fin-to-fin spacing.

Additionally, or alternatively, in this or other non-limiting examples, the inner surface defines an annular wall, the first plurality of fins extend from the annular wall and form a substantially rectangular passage.

Additionally, or alternatively, in this or other non-limiting examples, the second plurality of fins includes a first number of fins having the second fin-to-fin spacing and a second number of fins having a fourth fin-to-fin spacing that is greater than the second fin-to-fin spacing.

Additionally, or alternatively, in this or other non-limiting examples, the second number of fins extends from the first number of fins toward the second end portion.

Additionally, or alternatively, in this or other non-limiting examples, the second number of fins is provided only on select portions of the inner surface portion.

Additionally, or alternatively, in this or other non-limiting examples, the transformer bobbin includes a first bobbin joined to a second bobbin the first bobbin and the second bobbin being additively manufactured.

Additionally, or alternatively, in this or other non-limiting examples, a heat pipe is provided in the second bobbin member.

Additionally, or alternatively, in this or other non-limiting examples, each of the first bobbin member and the second bobbin member are formed from one of polyetheretherketone (PEEK), polyetherketoneketone (PEKK), Acrylonitrile butadiene styrene (ABS) plastic, Polycarbonate (PC), and polyetherimide plastic (PEI).

Disclosed, in accordance with another non-limiting example, is a transformer including a core having a first limb, a second limb, a first yoke, and a second yoke forming a magnetic flow path. A bobbin assembly includes a first bobbin mounted to the first limb, and a second bobbin mounted to the second limb, wherein each of the first bobbin and the second bobbin includes a first bobbin member including a first end defining a first opening, a second end defining a second opening, an inner surface defining the first opening and an outer surface. The inner surface includes a first plurality of fins that extend between the first end and the second end. A second bobbin member is disposed about and spaced from the first bobbin member. The second bobbin member includes a first end portion defining a first opening portion, a second end portion, an inner surface portion and an outer surface portion. One of the outer surface of the first bobbin member and the outer surface portion of the second bobbin member includes a second plurality of fins that extend between the first end portion and the second end portion.

Additionally, or alternatively, in this or other non-limiting examples, a third bobbin member is disposed about and spaced from the second bobbin member, the third bobbin member including a first end section defining a first opening section, a second end section, an inner surface section and an outer surface section, wherein one of the outer surface section and the inner surface section include a plurality of winding support members that extend between the first end section and the second end section.

Additionally, or alternatively, in this or other non-limiting examples, the first plurality of fins includes a first fin-to-fin spacing and the second plurality of fins includes a second fin-to-fin spacing, the first fin-to-fin spacing being distinct from the second fin-to-fin spacing.

Additionally, or alternatively, in this or other non-limiting examples, the inner surface defines an annular wall, the first plurality of fins extend from the annular wall and form a substantially rectangular passage.

Additionally, or alternatively, in this or other non-limiting examples, the second plurality of fins includes a first number of fins having the second fin-to-fin spacing and a second number of fins having a fourth fin-to-fin spacing that is greater than the second fin-to-fin spacing.

Additionally, or alternatively, in this or other non-limiting examples, the second number of fins extends from the first number of fins toward the second end portion.

Additionally, or alternatively, in this or other non-limiting examples, the second number of fins is provided only on select portions of the inner surface portion.

Additionally, or alternatively, in this or other non-limiting examples, a first winding is disposed about the first bobbin member and a second winding disposed about the second bobbin member.

Additionally, or alternatively, in this or other non-limiting examples, the first bobbin and the second bobbin are additively manufactured and integrally formed with one another.

Additionally, or alternatively, in this or other non-limiting examples, a heat pipe is provided in the second bobbin member.

### BRIEF DESCRIPTION OF THE DRAWINGS

The following descriptions should not be considered limiting in any way. With reference to the accompanying drawings, like elements are numbered alike:

FIG. 1 is a side view of a transformer including a bobbin assembly having integrated fins, in accordance with a non-limiting example;

FIG. 2 is a top view of the transformer of FIG. 1, in accordance with a non-limiting example;

FIG. 3 is a partial perspective view of the bobbin assembly of FIG. 1 showing a cut-away view of a bobbin of the bobbin assembly, in accordance with a non-limiting example;

FIG. 4 is a detail view of a portion of a bobbin of the bobbin assembly of FIG. 2, in accordance with a non-limiting example; and

FIG. 5 is a schematic cross-sectional side view of a bobbin of the bobbin assembly of FIG. 1, in accordance with a non-limiting example.

### DETAILED DESCRIPTION

A detailed description of one or more embodiments of the disclosed apparatus and method are presented herein by way of exemplification and not limitation with reference to the Figures.

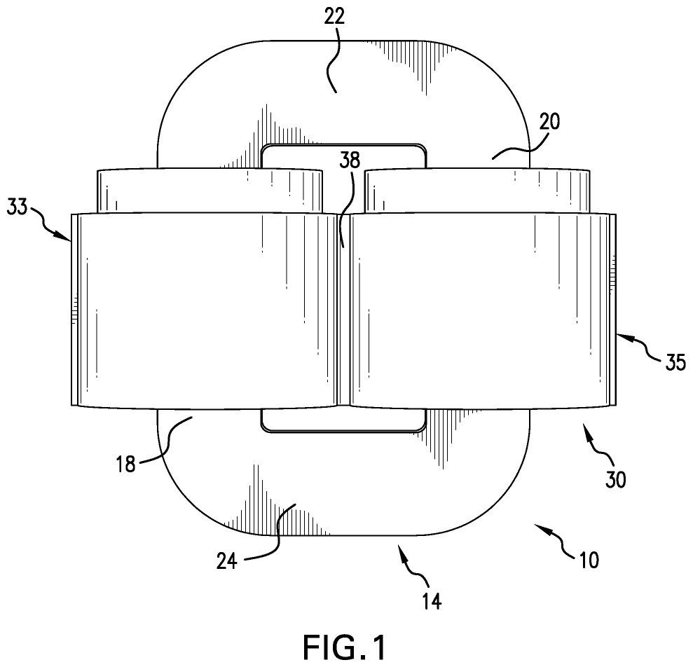

A transformer, in accordance with a non-limiting example, is indicated at 10 in FIG. 1. Transformer 10 takes the form of a high frequency solid state transformer that relies on modulation demodulation techniques to transform an input current to a selected output. Transformer 10 includes a core 14 having a first limb 18, a second limb 20, a first yoke 22, and a second yoke 24. Core 14 may be formed from a plurality of stacked laminations or from a solid block of material. Core 14 may also be formed in sections that are joined together. Core 14 is formed from a material that is magnetically conductive such as iron. First yoke 22 and second yoke 24 join first limb 18 and second limb 20 to form a magnetic flow path.

In a non-limiting example, a bobbin assembly 30 is mounted to core 14. Bobbin assembly 30 includes a first bobbin 33 mounted to first limb 18 and a second bobbin 35 mounted to second limb 20. First bobbin 33 may be connected to second bobbin 35 by a bridge 38. In a non-limiting example, bobbin assembly 30 is additively manufactures such that first bobbin 33 and second bobbin 35 are formed substantially simultaneously. Further, bobbin assembly 30 may be formed as two separate halves that are joined together about first limb 18 and second limb 20. In a non-limiting example, bobbin assembly 30 is formed from a non-electrically, non-magnetically conductive material such as polyetheretherketone (PEEK), polyetherketoneketone (PEKK), Acrylonitrile butadiene styrene (ABS) plastic, Polycarbonate (PC), and/or polyetherimide plastic (PEI).

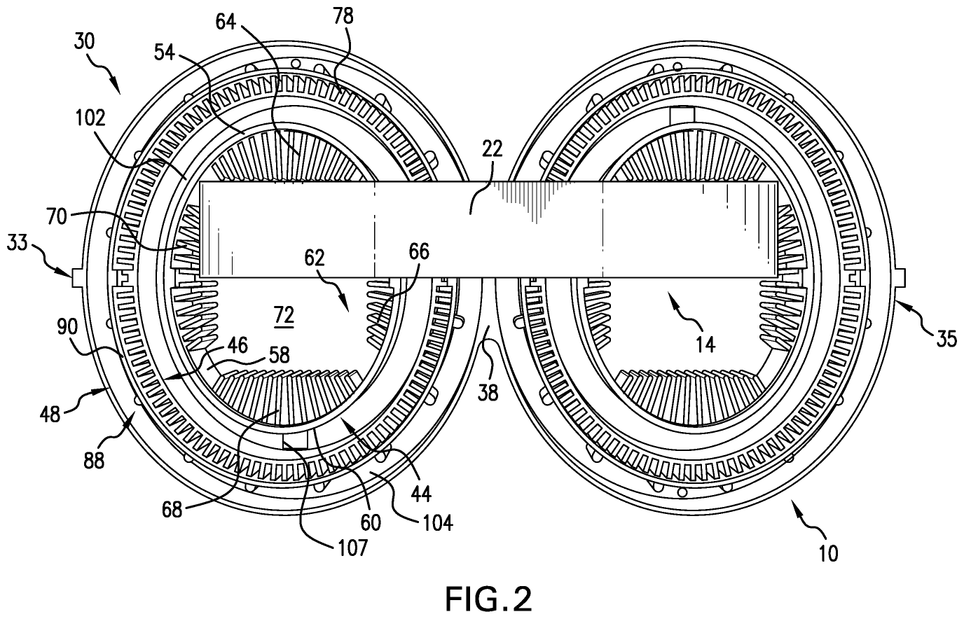

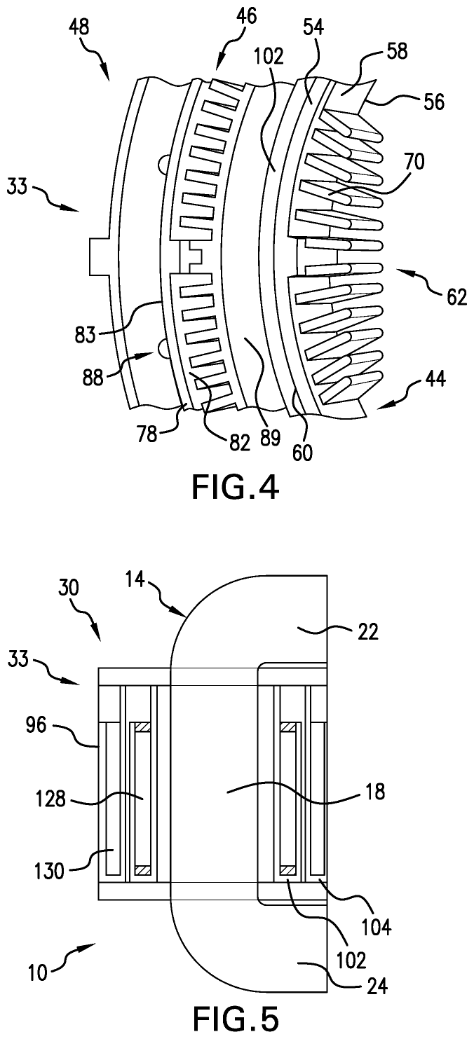

Reference will now follow to FIGS. 2-4 in describing first bobbin 33 with an understanding that second bobbin 35 includes corresponding structure. In accordance with a non-limiting example, first bobbin 33 includes a first bobbin member 44, a second bobbin member 46 arranged radially outwardly of first bobbin member 44, and a third bobbin member 48 arranged radially outwardly of second bobbin member 46. First, second, and third bobbin members 44, 46, and 48 define channels for passing a heat exchange medium over core 14 and transformer windings as will be discussed herein. Further, first, second, and third bobbin members 44, 46, and 48 provide support for the transformer windings.

In a non-limiting example, first bobbin member 44 includes a first end 54, a second end 56, an inner surface 58, and an outer surface 60. Second end 56 is opposite to first end 54. First bobbin member 44 includes a first plurality of fins 62 that extends radially inwardly from inner surface 58. First plurality of fins 62 are arranged in a first group 64, a second group 66, a third group 68, and a fourth group 70. First group 64 extends toward third group 68 and second group 66 extends toward fourth group 70 creating, in accordance with a non-limiting example, a substantially rectangular passage 72. Passage 72 extends from a first opening (not separately labeled) defined at first end 54 to a second opening (also not separately labeled) defined by second end 56. Passage 72 is receptive of first limb 18. As will be detailed herein, first plurality of fins 60 both retain and provide channels for a heat exchange medium that is moved over first limb 18.

In accordance with a non-limiting example, second bobbin member 46 includes a first end portion 78, a second end portion 80 that is opposite first end portion 78, an inner surface portion 82, and an outer surface portion 83. A second plurality of fins 84 is arranged on inner surface portion 82. Second bobbin member 46 includes a first opening portion 86 at first end portion 78. A plurality of winding support members 88 is arranged on outer surface portion 83. First plurality of fins 62 includes a first fin-to-fin spacing and second plurality of fins 84 includes a second fin-to-fin spacing. In a non-limiting example, first fin-to-fin spacing is greater than second fin-to-fin spacing.

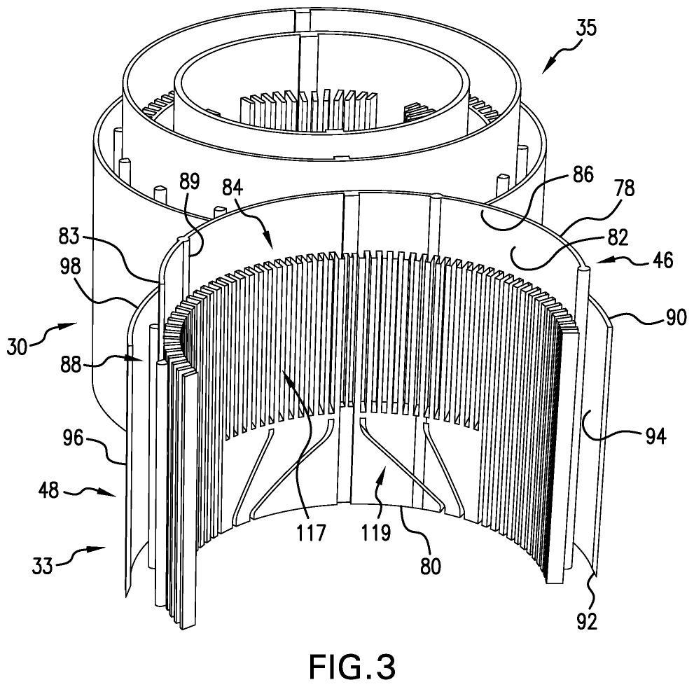

In a non-limiting example, second bobbin member 46 may include one or more heat pipes such as indicated at 89 in FIG. 3. Heat pipes 90 may be embedded between inner surface portion 82 and outer surface portion 83. Heat pipes 90 may cooperate with second plurality of fins 84 to wick away heat from second bobbin member 46. The location and arrangement of heat pipes 90 may vary and should not be limited to the locations and number shown.

In accordance with a non-limiting example, third bobbin member 48 includes a first end section 90, a second end section 92 that is opposite first end section 90, an inner surface section 94 and an outer surface section 96 that forms an exterior wall (not separately labeled) of first bobbin 33. First end section 90 defines a first opening section 98 of third bobbin member 48. In a non-limiting example, second bobbin member 46 includes a first base 102 and third bobbin member 48 includes a second base 104. In a non-limiting example, first base 102 includes an opening 107 that allows a heat exchange medium, such as forced air, to enter into first bobbin 33.

In a non-limiting example, second plurality of fins 84 is divided into two groups as shown in FIG. 3. A first number 117 of the second plurality of fins 84 includes the second fin-to-fin spacing and extends entirely annularly about inner surface portion 82. A second number 119 of the second plurality of fins includes a fourth fin-to-fin spacing and is arranged at select portions of inner surface portion 82. The second number 119 of the second plurality of fins also include multiple angles that serve to channel the heat exchange medium.

In a non-limiting example, the second number 119 of the second plurality of fins 84 are arranged on portions of inner surface portion 82 that are adjacent to second yoke 24. That is, second yoke 24 may act as a blocking member or deflector that creates areas of poor heat exchange in the second plurality of fins 84. By positioning the second number 119 of the second plurality of fins 84 on inner surface portion 82 adjacent to second yoke 24, the heat exchange medium is more uniformly introduced into first bobbin 33.

In a non-limiting example, first bobbin 33 supports a first or inner winding 128 between first bobbin member 44 and second bobbin member 46 and a second or outer winding 130 between second bobbin member 46 and third bobbin member 48. The second plurality of fins 84 create channels or flow paths that are receptive to a heat exchange medium that flows in contact with first winding 128 and second winding 130. By creating multiple flow channels that guide a forced flow of heat exchange medium such as air into contact with first winding 128 and second winding 130, transformer 10 may operate at higher temperatures such as those associated with a high frequency solid state system. That is, the first and second plurality of fins 62, 84, create a flow pattern that facilitates an enhanced heat exchange between core 14, first winding 128, and second winding 130 that enables transformer 10 to shed a large heat volume. The incorporation of heat pipes 90 removes additional heat that might have a negative impact on performance. By removing a large heat volume, transformer 10 is enabled to operate at a selected voltage and frequency and endure for a desired lifespan. The transformer may also be provided in a smaller package that facilitates use in an aircraft.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A transformer bobbin comprising:
a first bobbin member including a first end defining a first opening, a second end defining a second opening, an inner surface defining the first opening and an outer surface, the inner surface including a first plurality of fins that extend between the first end and the second end; and
a second bobbin member disposed about and spaced from the first bobbin member, the second bobbin member including a first end portion defining a first opening portion, a second end portion, an inner surface portion and an outer surface portion, wherein one of the outer surface of the first bobbin member and the outer surface portion of the second bobbin member includes a second plurality of fins that extend between the first end portion and the second end portion.

2. The transformer bobbin according to claim 1, further comprising: a third bobbin member disposed about and spaced from the second bobbin member, the third bobbin member including a first end section defining a first opening section, a second end section, an inner surface section and an outer surface section, wherein one of the outer surface section and the inner surface section include a plurality of winding support members that extend between the first end section and the second end section.

3. The transformer bobbin according to claim 2, wherein the first plurality of fins includes a first fin-to-fin spacing and the second plurality of fins includes a second fin-to-fin spacing, the first fin-to-fin spacing being distinct from the second fin-to-fin spacing.

4. The transformer bobbin according to claim 2, wherein the inner surface defines an annular wall, the first plurality of fins extend from the annular wall and form a substantially rectangular passage.

5. The transformer bobbin according to claim 2, wherein the second plurality of fins includes a first number of fins having the second fin-to-fin spacing and a second number of fins having a fourth fin-to-fin spacing that is greater than the second fin-to-fin spacing.

6. The transformer bobbin according to claim 5, wherein the second number of fins extends from the first number of fins toward the second end portion.

7. The transformer bobbin according to claim 6, wherein the second number of fins is provided only on select portions of the inner surface portion.

8. The transformer bobbin according to claim 1, wherein the transformer bobbin includes a first bobbin joined to a second bobbin the first bobbin and the second bobbin being additively manufactured.

9. The transformer bobbin according to claim 1, further comprising: a heat pipe provided in the second bobbin member.

10. The transformer bobbin according to claim 1, wherein each of the first bobbin member and the second bobbin member are formed from one of polyetheretherketone (PEEK), polyetherketoneketone (PEKK), Acrylonitrile butadiene styrene (ABS) plastic, Polycarbonate (PC), and polyetherimide plastic (PEI).

11. A transformer comprising:
a core having a first limb, a second limb, a first yoke, and a second yoke forming a magnetic flow path;
a bobbin assembly including a first bobbin mounted to the first limb, and a second bobbin mounted to the second limb, wherein each of the first bobbin and the second bobbin includes
a first bobbin member including a first end defining a first opening, a second end defining a second opening, an inner surface defining the first opening and an outer surface, the inner surface including a first plurality of fins that extend between the first end and the second end; and
a second bobbin member disposed about and spaced from the first bobbin member, the second bobbin member including a first end portion defining a first opening portion, a second end portion, an inner surface portion and an outer surface portion, wherein one of the outer surface of the first bobbin member and the outer surface portion of the second bobbin member includes a second plurality of fins that extend between the first end portion and the second end portion.

12. The transformer according to claim 11, further comprising: a third bobbin member disposed about and spaced from the second bobbin member, the third bobbin member including a first end section defining a first opening section, a second end section, an inner surface section and an outer surface section, wherein one of the outer surface section and the inner surface section include a plurality of winding support members that extend between the first end section and the second end section.

13. The transformer according to claim 12, wherein the first plurality of fins includes a first fin-to-fin spacing and the second plurality of fins includes a second fin-to-fin spacing, the first fin-to-fin spacing being distinct from the second fin-to-fin spacing.

14. The transformer according to claim 12, wherein the inner surface defines an annular wall, the first plurality of fins extend from the annular wall and form a substantially rectangular passage.

15. The transformer according to claim 12, wherein the second plurality of fins includes a first number of fins having the second fin-to-fin spacing and a second number of fins having a fourth fin-to-fin spacing that is greater than the second fin-to-fin spacing.

16. The transformer according to claim 15, wherein the second number of fins extends from the first number of fins toward the second end portion.

17. The transformer according to claim 16, wherein the second number of fins is provided only on select portions of the inner surface portion.

18. The transformer according to claim 11, further comprising: a first winding disposed about the first bobbin member and a second winding disposed about the second bobbin member.

19. The transformer according to claim 11, wherein the first bobbin and the second bobbin are additively manufactured and integrally formed with one another.

20. The transformer according to claim 11, further comprising: a heat pipe provided in the second bobbin member.
